(19) United States
(12) Patent Application Publication
(10) Pub. No.: US 2009/0116367 A1
(43) Pub. Date: May 7, 2009

(54) FERROELECTRIC RECORD CARRIER, ITS METHOD OF MANUFACTURE AND MICRO-TIP RECORDING SYSTEM INCORPORATING SAME

(75) Inventor: Serge Gidon, LA MURETTE (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: COMMISSARIAT A L'ENERGIE ATOMIQUE

(21) Appl. No.: 12/262,655

(22) Filed: Oct. 31, 2008

(30) Foreign Application Priority Data
Nov. 6, 2007 (FR) 07/07781

(51) Int. Cl. G11B 9/00; B32B 3/02; B05D 5/12

(52) U.S. Cl. 369/126; 428/64.2; 428/64.4; 427/124; 427/577; G9B/9

(57) ABSTRACT

The present invention relates to a data record carrier of the type with ferroelectric memory layer, its method of manufacture and a micro-tip recording system incorporating same. The invention applies in particular to computer-based or multimedia applications requiring high memory capacities. A record carrier according to the invention comprises a substrate, a counter-electrode deposited on the substrate and intended to cooperate with an electrode of a data reading and/or writing device, and at least one ferroelectric memory layer which is able to store these data and which exhibits a first face in close contact with said counter-electrode. According to the invention, the counter-electrode is made of a substance comprising a carbonaceous material chosen from the group consisting of carbon in the form of graphite or amorphous diamond, the carbides of a metallic or non-metallic element with the exclusion of ionic carbides, and their mixtures.

### CROSS REFERENCE TO RELATED APPLICATIONS

This application claims priority from French application number 07/07781, filed Nov. 6, 2007.

### FIELD OF THE INVENTION

The present invention relates to a data record carrier of the type with ferroelectric memory layer, its method of manufacture and a micro-tip recording system incorporating same. The invention applies in particular to computer-based or multimedia applications requiring high memory capacities.

### BACKGROUND OF THE INVENTION

The various data recording techniques are generally classed using the terms “mass memories” (e.g. hard disks, optical disks) and “dynamic memories” (e.g. Dynamic Random Access Memories “DRAMs”, flash memories, etc.), these dynamic memories also being called “solid-state memories” insofar as no mechanical element is used. At the margin of these areas there exists another sort of memory of the so-called micro-tip type, whose operation relies on an integrated micromechanical element. The surface density and the parallelism of the access means predispose these micro-tip memories to applications involving large capacity in a small volume, as expected in “roaming” devices and also in fixed devices of large capacity.

These micro-tip memories rely on writing information onto a record carrier, by means of micrometric tips of nanometric apex dimension, which enable surface properties of the carrier to be modified locally. One thus expects to achieve storage densities equal to or even greater than 0.15 Terabits/cm². As presented in article [1], the IBM group has in particular developed plastic media in which heated micro-tips are able to make nano-holes with densities of the order of 0.15 Terabits/cm². A major drawback of this thermal technique resides in its high energy consumption.

Among the known electrical recording techniques, mention may be made of those using phase change materials (cf. Article [2]) which show beneficial performance in terms of energy consumption, but whose erasure process has not been proven. In this case, it is the crystallization state of the memory material which is modified by the Joule effect (electric mode) over a zone of the record carrier designated by the micro-tip. The crystallinity state of the surface of this material is read by detecting its local conduction.

It is also known to use data recording media based on ferroelectric materials for the persistent and reversible storage of information in the form of nanometric domains. This technique, very promising in terms of storage densities and “cyclability”, uses the natural bi-stability of ferroelectric materials which are able to retain a state of electric polarization after the disappearance of the electric field applied. Several procedures are currently used to (re)read the state of ferroelectric memories.

A first procedure, initially described in article [3], consists in detecting the state of the memory by piezoelectric response, i.e. by analyzing the mechanical response of the memory domain to an electrical excitation. The state of the memory appears to be in phase or in phase opposition with the disturbing electrical loading, depending on the so-called “up” or “down” state of this memory. This approach exploits the piezoelectric behavior of the ferroelectric material that is found for example in PZT ceramics of formula Pb(Zrₓ,Ti₁₋ₓ)O₃, lithium tantalate (LiTaO₃) and lithium niobate (LiNbO₃).

A second procedure consists in detecting the variation in capacitance under the micro-tip, which variation is associated with the change of ferroelectric state, as described in article [4]. This approach is beneficial, because it seems to give the highest storage densities, typically of the order of 1.5 Terabits/cm².

Whatever mode of detection is envisaged—piezoelectric or capacitive—for recording, (re)reading and writing information in a ferroelectric carrier, it is necessary to place an electrically conducting counter-electrode directly under the ferroelectric memory layer.

These known recording techniques using ferroelectric memory layers exhibit the following major drawbacks however.

A first drawback of these techniques with ferroelectric memory layers resides in the fact that the metal counter-electrodes commonly used under the ferroelectric memory layer are typically based on aluminum or chromium, and this may generate “contamination” processes at the interface with the ferroelectric material, which interface must be as intimate as possible. Specifically, the oxidized states of these metals cause the appearance, in contact with the ferroelectric layer (for example based on lithium niobate or tantalate), of an interface layer which exhibits a low electrical susceptibility compared with that, which is substantially greater, of the ferroelectric material used (of dipolar and ionic polarization type). Now, it turns out that this interface layer screens the electric field applied by the micro-tips and therefore limits the effectiveness of its action (for both reading and writing), compelling the operator to use larger electric voltages between the micro-tips and the counter-electrode to alleviate this impairment of the interface between counter-electrode and memory layer.

A second drawback of these techniques with ferroelectric memory layers resides in the fact that the free surface of the memory layer (such as that freed by the “Smart Cut” method, see article [6], or else that obtained by polishing) may be chemically contaminated, in particular by the presence of water (see again article [4]), this contamination resulting in poor electrostatic contact between the micro-tips and the ferroelectric layer. Moreover, these memory layers are in general the hub of relatively early mechanical wear.

### SUMMARY OF THE INVENTION

An aim of the present invention is to propose a data record carrier comprising a substrate, a counter-electrode deposited on said substrate which is made of a substance comprising a carbonaceous material and which is intended to cooperate with an electrode of a device for reading and/or writing these data, and at least one ferroelectric memory layer which is able to store these data and which exhibits a first face in close contact with said counter-electrode, which makes it possible to remedy the aforesaid drawbacks and in particular that inherent in the impairment of the interface between the counter-electrode and the memory layer.

For this purpose, said carbonaceous material is chosen from the group consisting of carbon in the form of graphite, carbon in the form of amorphous diamond (“DLC”), the carbides of a metallic or non-metallic element with the exclusion of ionic carbides, and their mixtures.

It will be noted that this carbonaceous material used for the counter-electrode of the record carrier according to the invention makes it possible to avoid the aforesaid impairment or “contamination” of the interface between this counter-electrode and the ferroelectric memory layer and, consequently, not to impede the electric field applied by the micro-tips of the reading/writing device according to the invention. It follows from this that it is possible to work with a relatively reduced electric voltage between the micro-tips and this record carrier.

Preferably, said counter-electrode consists predominantly of said carbonaceous material and, even more preferentially, it consists exclusively of this carbonaceous material.

Advantageously, said counter-electrode comprising this carbonaceous material can exhibit an electrical conductivity of between 0.1 S/m and 100 S/m.

It will be noted that with a relatively reduced electrical conductivity such as this for the counter-electrode, the conductance of this counter-electrode is not very high, but this does not adversely affect the recording, reading and writing of data on the record carrier according to the invention, because these functions operate essentially electrostatically.

According to a first exemplary embodiment of the invention, said carbonaceous material consists of carbon in all its forms of chemical bonds (i.e. sp2 or sp3 hybridizations).

The carbon used can then be in the form of graphite, deposited for example by vapor phase physical deposition (“PVD”: “Physical Vapor Deposition”), or else of carbon in the form of amorphous diamond (“DLC”: “Diamond Like Carbon”), deposited for example by vapor phase chemical deposition (“CVD”: Chemical Vapor Deposition”) or plasma enhanced vapor phase chemical deposition (“PECVD”: “Plasma Enhanced Chemical Vapor Deposition”). This carbon can be rendered more conducting if laden with electrically conducting elements present at a reduced fraction, such as nickel, chromium, silver, silicon or boron.

According to a second exemplary embodiment of the invention, said carbonaceous material consists of at least one carbide of a metallic element preferably chosen from the group consisting of titanium, zirconium, tungsten and hafnium, or else of at least one carbide of a non-metallic element, preferably silicon or boron.

According to another characteristic of the invention, said counter-electrode can advantageously exhibit a thickness of between 10 nm and 500 nm, preferably substantially equal to 100 nm.

According to another characteristic of the invention, said ferroelectric memory layer is based on at least one ferroelectric compound that can advantageously be chosen from the group consisting of PZT ceramics of formula Pb(Zrₓ,Ti₁₋ₓ)O₃, lithium tantalate (LiTaO₃), potassium tantalate (KTaO₃), strontium ruthenate (SrRuO₃), barium titanate (BaTiO₃), strontium titanate (SrTiO₃), and lithium niobate (LiNbO₃) and their mixtures. It will be noted nevertheless that it would also be possible to use any other known ferroelectric material, to embody this memory layer.

Advantageously, the record carrier can furthermore comprise a protective layer which is intended to protect a second face of said ferroelectric memory layer opposite to said first face, in particular from external pollution and mechanical wear in relation to said reading and/or writing device, said protective layer exhibiting an electrical conductivity which is less than 1 S/m and preferably less than 10⁻⁴ S/m and which is dependent on the leakage currents of said memory layer.

It will be noted that this protective layer according to the invention makes it possible to avoid chemical contamination (in particular by external water) of the free surface of the memory layer, thereby making it possible not to penalize the electrostatic contact between the micro-tips of the reading/writing device and the record carrier according to the invention. In addition to protecting the memory layer against chemical attacks, this protective layer is designed to delay the mechanical wear of the ferroelectric layer, while facilitating its electrical contact with the micro-tips.

According to another characteristic of the invention, said protective layer can consist of carbon in the pure state deposited for example by vapor phase chemical deposition, vapor phase physical deposition or plasma enhanced vapor phase chemical deposition and, advantageously, this protective layer consists of carbon in the form of amorphous diamond, preferably deposited by plasma enhanced vapor phase chemical deposition.

Also advantageously, said protective layer can exhibit a thickness of less than 5 nm. As will be noted this extremely reduced thickness makes it possible not to penalize the operations of reading/writing the record carrier by the corresponding device.

A data recording system according to the invention, which comprises a data record carrier and a data reading and/or writing device of the type comprising an array of micro-tips able to locally modify the properties of at least one ferroelectric memory layer of said carrier, is characterized in that this record carrier is such as defined above.

It will be noted that the electric field (which causes the flipping of the ferroelectric domains) is normally applied according to the invention between the micro-tip and the counter-electrode. They must therefore be either side of the ferroelectric material and as close as possible to one another, so that the electric field is strong (i.e. capable of being higher than the coercive field of the material) in order to write an item of information.

According to another characteristic of the invention, said ferroelectric memory layer can advantageously be adapted to exhibit an inverse piezoelectric effect in response to electrical loadings of said device transmitted by said electrode and said counter-electrode (see the aforesaid article [3]), so that the state of said memory layer is detected by detecting its mechanical responses to these loadings.

As a variant, said ferroelectric memory layer according to the invention can be adapted to exhibit variations of electrical capacitance in response to excitations generated by a resonant circuit of said device, so that the state of said memory layer is detected by detecting said variations (see the aforesaid article [4]).

In a general way, it will be noted that the record carrier according to the present invention is not limited to its use with a reading and/or writing device of micro-tip type, and that this carrier of the invention could be applied to data recording systems of solid-state or dynamic memory type, forming for example a dynamic random access memory (“DRAM”) or a flash memory.

The method according to the invention for manufacturing a record carrier such as defined above comprises a deposition of the material forming said counter-electrode on said first face of the memory layer by vapor phase chemical deposition, vapor phase physical deposition or plasma enhanced vapor phase chemical deposition.

According to another characteristic of the invention, this method furthermore comprises a subsequent deposition by vapor phase chemical deposition, vapor phase physical deposition or plasma enhanced vapor phase chemical deposition, on a second face of said memory layer opposite to said first face, of a protective layer which is in particular intended to protect this second face from external pollution and mechanical wear in relation to the reading and/or writing device and which exhibits an electrical conductivity of less than 1 S/m and preferably less than 10⁻⁴ S/m.

Advantageously, said protective layer is applied via a vapor phase chemical deposition of carbon preferably in the form of amorphous diamond, this deposition being enhanced by a high-frequency plasma.

According to another characteristic of the invention, prior to each of these two depositions, counter-electrode and protective layer, said first and/or second face(s) of the memory layer is(are) advantageously prepared by mechanical polishing (for example by the “CMP” technique: “Chemical-Mechanical Polishing”, i.e. mechano-chemical planarization or polishing), to ensure the planarity of the adhesion interface, then by chemical attack or etching (for example according to the “RIE” technique, i.e. “Reactive Ion Etching” i.e. chemically reactive plasma enhanced etching, or else “RF Etch” i.e. etching using radiofrequencies), to extract therefrom any organically contaminated sub-layers.

According to a first embodiment of the invention, the method of manufacture comprises essentially the following steps:

the material forming said counter-electrode is deposited on said substrate, preferably silicon,

an outline of said ferroelectric memory layer is added onto this substrate thus overlaid with this counter-electrode,

the thickness of this outline is reduced to obtain the memory layer according to a thickness of for example less than 100 nm, then

the protective layer is deposited on the memory layer.

According to a second embodiment of the invention, the method of manufacture comprises essentially the following steps:

a) hydrogen and/or helium ions are implanted in a ferroelectric carrier layer intended to constitute said memory layer,

b) the material forming the counter-electrode is deposited at the surface on this carrier layer, to make the counter-electrode adhere to said first face of the memory layer,

c) this carrier layer thus overlaid with the counter-electrode is transferred by pressure onto said substrate, preferably of silicon, in such a manner that the counter-electrode adheres to said substrate,

d) said carrier layer is broken along the barrier plane stopping said ions by expansion, to obtain the memory layer terminating in said second face with a reduced thickness of for example less than 50 nm, then

e) said protective layer is deposited on this second face, to obtain the record carrier according to the invention.

Advantageously, the method according to this second embodiment of the invention can furthermore comprise, to obtain in step c) improved adhesion of the counter-electrode to the substrate, a prior deposition by “PECVD” or “CVD” of a silica layer (SiO₂) on this counter-electrode. This silica layer exhibits a thickness of preferably between 10 nm and 100 nm.

### BRIEF DESCRIPTION OF THE DRAWINGS

The aforesaid characteristics of the present invention, together with others, will be better understood on reading the following description of several exemplary embodiments of the invention, given by way of nonlimiting illustration, said description being given in conjunction with the attached drawings, among which:

FIG. 1 is a schematic view illustrating a step of the method of manufacturing a record carrier according to the second mode of the invention, showing in transverse section the assembly on a substrate of a ferroelectric carrier layer overlaid with the counter-electrode,

FIG. 2 is a schematic view in transverse section showing the intermediate stack obtained by the assembly step of FIG. 1,

FIG. 3 is a schematic view in transverse section showing the result of a subsequent step of the method according to this second mode of the invention, implemented on the intermediate stack of FIG. 2, and

FIG. 4 is a schematic view in transverse section showing the record carrier ultimately obtained by this second mode of the invention, by implementing a subsequent step of depositing a protective layer on the stack of FIG. 3.

### DETAILED DESCRIPTION

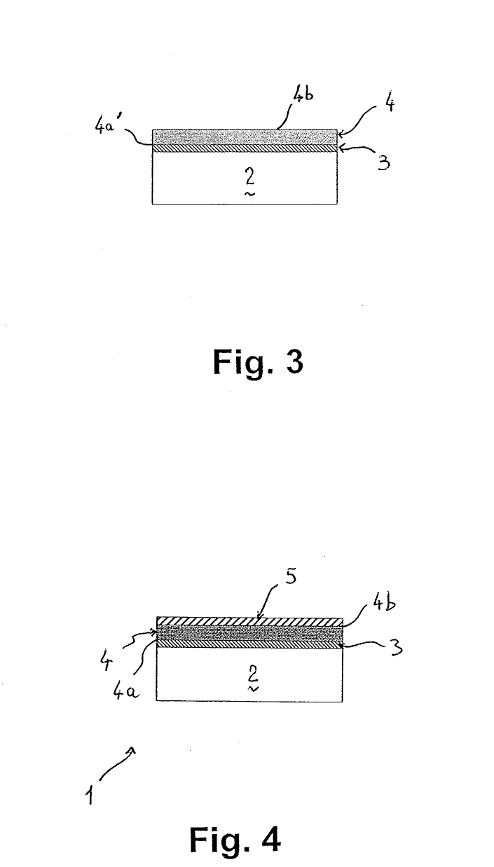

As illustrated in FIG. 4, a data record carrier 1 according to the invention, which is in particular intended to cooperate with a reading and/or writing device (not represented) of the type comprising micro-tips, is preferably formed of the following stack of layers:

a substrate 2 of for example silicon;

a counter-electrode 3 deposited on the substrate 2 preferably by vapor phase chemical deposition, vapor phase physical deposition or plasma enhanced vapor phase chemical deposition, and intended to cooperate with an electrode of the reading and/or writing device, this counter-electrode 3 exhibiting a thickness of for example the order of 100 nm and an electrical conductivity of between 0.1 S/m and 100 S/m and preferably consisting of carbon (in the form of graphite or amorphous diamond) or of a non-ionic carbide such as a carbide of titanium, zirconium, tungsten, hafnium, silicon or of boron;

a ferroelectric memory layer 4 able to store these data and exhibiting a first face 4a in close contact with the counter-electrode 3, this layer 4 being for example formed of a PZT ceramic, of lithium or potassium tantalate, of strontium ruthenate, of barium or strontium titanate, or else of lithium niobate; and

a protective layer 5 which is preferably deposited via a vapor phase chemical deposition of carbon (advantageously “DLC” carbon, i.e. in the form of amorphous diamond) enhanced by a high-frequency plasma, and which is intended to protect a second face 4b of the memory layer 4 opposite to the first face 4a in particular from external pollution and mechanical wear in relation to the reading and/or writing device, this layer 5 preferably exhibiting a thickness of less than 5 nm, an electrical conductivity of less than 10⁻⁴ S/m and being formed of pure carbon, advantageously in the form of amorphous diamond.

It will be noted that this method of plasma enhanced vapor phase chemical deposition (“PECVD”) can comprise in particular a cracking of reagents containing carbon, such as methane, by means of a high-frequency plasma, so as to free the active carbon which then deposits itself on the free surface of the ferroelectric layer 4.

It will also be noted that it is possible to implement other carbon deposition methods to deposit this protective layer 5, such as vapor phase physical deposition (“PVD”) or vapor phase chemical deposition (“CVD”), by way of nonlimiting example.

With reference to article [5], the record carrier 1 illustrated in FIG. 4 can be obtained by implementing the following successive steps, according to the first embodiment of the invention:

the material forming the counter-electrode 3 is deposited on the substrate 2,

an outline of the ferroelectric memory layer 4 is added onto this substrate 2 thus overlaid with the counter-electrode 3,

the thickness of this outline is reduced to obtain the memory layer 4 according to a thickness of for example less than 100 nm, then

the protective layer 5 is deposited on this memory layer 4.

With reference to article [6], the record carrier 1 illustrated in FIG. 4 can be obtained by implementing the following successive steps, according to the second embodiment of the invention:

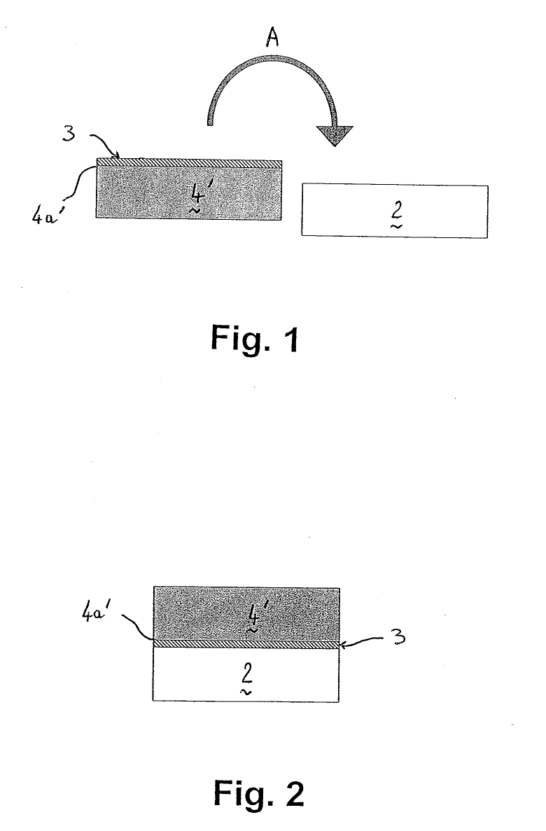

hydrogen and helium ions are implanted beforehand in a ferroelectric carrier layer 4′ intended to constitute the memory layer 4 (this ion implantation step is not illustrated in FIG. 1),

the material forming the counter-electrode 3 is deposited at the surface on the carrier layer 4′, to make the counter-electrode 3 adhere to the first face 4a′ of this layer 4′, as illustrated in FIG. 1,

this carrier layer 4′ thus overlaid with the counter-electrode 3 is transferred by pressure (see arrow A of FIG. 1) onto the substrate 2, so that this counter-electrode 3 adheres to it as illustrated in FIG. 2, it being specified that a prior deposition of a silica layer 10 to 100 nm thick on the counter-electrode 3 is advantageously carried out, to obtain improved adhesion of the latter to the substrate 2,

the carrier layer 4′ is broken along the barrier plane stopping the implanted ions (see FIG. 3), to obtain the memory layer 4 terminating in the second face 4b with a thickness of for example less than 50 nm, then

the protective layer 5 is deposited on this second face 4b, to obtain the record carrier 1 illustrated in FIG. 4.

Whether the first or the second modes of fabrication are used to manufacture the record carrier 1 according to the invention, it will be noted that the first and the second faces 4a and 4b of the memory layer 4 are advantageously prepared, before the aforesaid depositions of the counter-electrode 3 and of the protective layer 5, by mechanical polishing to ensure the planarity of the adhesion interface, then by chemical attack or etching, to extract therefrom any organically contaminated sub-layers.

1. Data record carrier comprising a substrate, a counter-electrode deposited on said substrate which is made of a substance comprising a carbonaceous material and which is intended to cooperate with an electrode of a device for reading and/or writing these data, and at least one ferroelectric memory layer which is able to store these data and which exhibits a first face in close contact with said counter-electrode, wherein said carbonaceous material is selected from the group consisting of carbon in the form of graphite, carbon in the form of amorphous diamond (“DLC”), the carbides of a metallic or non-metallic element with the exclusion of ionic carbides, and their mixtures.

2. Record carrier according to claim 1, wherein said counter-electrode exhibits an electrical conductivity of between 0.1 S/m and 100 S/m.

3. Record carrier according to claim 1, wherein said counter-electrode consists exclusively of said carbonaceous material.

4. Record carrier according to one of claim 1, wherein said carbonaceous material consists of carbon in the form of graphite, deposited by vapor phase physical deposition.

5. Record carrier according to one of claim 1, wherein said carbonaceous material consists of carbon in the form of amorphous diamond (“DLC”), deposited by vapor phase chemical deposition or plasma enhanced vapor phase chemical deposition (“PECVD”).

6. Record carrier according to one of claim 1, wherein said carbonaceous material consists of at least one carbide of a metallic element selected from the group consisting of titanium, zirconium, tungsten and hafnium.

7. Record carrier according to claim 1, wherein said carbonaceous material consists of at least one carbide of a non-metallic element.

8. Record carrier according to claim 1, wherein said non-metallic element is silicon or boron.

9. Record carrier according to claim 1, wherein said counter-electrode exhibits a thickness of between 10 nm and 500 nm.

10. Record carrier according to claim 1, wherein said counter-electrode exhibits a thickness substantially equal to 100 nm.

11. Record carrier according to claim 1, wherein said ferroelectric memory layer is based on at least one ferroelectric compound selected from the group consisting of PZT ceramics of formula Pb(Zrₓ,Ti₁₋ₓ)O₃, lithium tantalate (LiTaO₃), potassium tantalate (KTaO₃), strontium ruthenate (SrRuO₃), barium titanate (BaTiO₃), strontium titanate (SrTiO₃), and lithium niobate (LiNbO₃) and their mixtures.

12. Record carrier according to claim 1 further comprising a protective layer to protect a second face of said ferroelectric memory layer opposite to said first face, from external pollution and mechanical wear in relation to said reading and/or writing device, said protective layer exhibiting an electrical conductivity which is less than 1 S/m and which is dependent on the leakage currents of said memory layer.

13. Record carrier according to claim 12, wherein said protective layer consists of carbon deposited by vapor phase chemical deposition, vapor phase physical deposition or plasma enhanced vapor phase chemical deposition.

14. Record carrier according to claim 13, wherein said protective layer consists of carbon in the form of amorphous diamond.

15. Record carrier according to one of claim 12, wherein said protective layer exhibits a thickness of less than 5 nm.

16. Recording system comprising a data record carrier and a data reading and/or writing device of the type comprising an array of micro-tips able to locally modify the properties of at least one ferroelectric memory layer of said carrier, characterized in that this record carrier is such as defined in claim 1.

17. Recording system according to claim 16, wherein said ferroelectric memory layer is adapted to exhibit an inverse piezoelectric effect in response to electrical loadings of said device transmitted by said electrode and said counter-electrode, so that the state of said memory layer is detected by detecting its mechanical responses to these loadings.

18. Recording system according to claim 16, characterized in that said ferroelectric memory layer is adapted to exhibit variations of electrical capacitance in response to excitations generated by a resonant circuit of said device, so that the state of said memory layer is detected by detecting said variations.

19. Method of manufacturing a record carrier according to claim 1, comprising deposition of material forming said counter-electrode on said first face of the memory layer by vapor phase chemical deposition, vapor phase physical deposition or plasma enhanced vapor phase chemical deposition.

20. Method of manufacture according to claim 19, further comprising a subsequent deposition by vapor phase chemical deposition, vapor phase physical deposition or plasma enhanced vapor phase chemical deposition, on a second face of said memory layer opposite to said first face, of a protective layer to protect this second face from external pollution and mechanical wear in relation to said reading and/or writing device and which exhibits an electrical conductivity of less than 1 S/m.

21. Method of manufacture according to claim 20, wherein said protective layer is applied via a vapor phase chemical deposition enhanced by a high-frequency plasma, of carbon preferably in the form of amorphous diamond.

22. Method of manufacture according to claim 20, wherein prior to each of the said two depositions, said first and/or second face(s) of the memory layer is(are) prepared by mechanical polishing, to ensure the planarity of the adhesion interface, then by chemical attack or etching, to extract therefrom any organically contaminated sub-layers.

23. Method of manufacture according to claim 22, wherein the method consists essentially the following steps:
the material forming said counter-electrode is deposited on said substrate, preferably silicon,
an outline of said ferroelectric memory layer is added onto this substrate thus overlaid with this counter-electrode,
the thickness of this outline is reduced to obtain the memory layer according to a thickness of for example less than 100 nm, then
said protective layer is deposited on this memory layer.

24. Method of manufacture according to claim 22, wherein the method consists essentially the following steps:
a) hydrogen and/or helium ions are implanted in a ferroelectric carrier layer intended to constitute said memory layer,
b) the material forming said counter-electrode is deposited at the surface on this carrier layer, to make the counter-electrode adhere to said first face of the memory layer,
c) this carrier layer thus overlaid with the counter-electrode is transferred by pressure onto said substrate, preferably of silicon, in such a manner that the counter-electrode adheres to said substrate,
d) said carrier layer is broken along the barrier plane stopping said ions by expansion, to obtain said memory layer terminating in said second face with a reduced thickness of for example less than 50 nm, then
e) said protective layer is deposited on this second face, to obtain the record carrier.

25. Method of manufacture according to claim 24, characterized in that, to obtain improved adhesion of said counter-electrode to the substrate in step c), a silica layer of between 10 nm and 100 nm in thickness is deposited beforehand on this counter-electrode.
